(19) United States
(12) Patent Application Publication
(10) Pub. No.: US 2012/0206649 A1
(43) Pub. Date: Aug. 16, 2012

(54) ENERGY-SAVING CONTROL DEVICE FOR REMOTE IMAGE RECEIVER

(75) Inventors: Szuyu Ho, New Taipei City (TW); Chih-Yuan Ho, New Taipei City (TW)

(73) Assignee: ABA ELECTRONICS TECHNOLOGY CO., LTD., New Taipei City (TW)

(21) Appl. No.: 13/101,359

(22) Filed: May 5, 2011

(30) Foreign Application Priority Data
Feb. 10, 2011 (TW) 100202535

(51) Int. Cl. H04N 5/63; H04N 9/47

(52) U.S. Cl. 348/503; 348/730; 348/E05.127; 348/E09.033

(57) ABSTRACT

An energy-saving control device for remote image receiver is disclosed. The control device is electrically connected to an image receiver, and includes a detection module, a control module, and a power control module. The detection module detects a differential signal transmission state at the remote image receiver, and generates a detection signal to the control module accordingly. The control module generates a control signal according to the detection signal, so as to control the power control module to control on/off of power supply to the image receiver. With these arrangements, it is able to control the image receiver to automatically turn off when the differential signal transmission stops, so as to achieve the effects of energy saving and extended service life of the image receiver.

This application claims the priority benefit of Taiwan patent application number 100202535 filed on Feb. 10, 2011.

### FIELD OF THE INVENTION

The present invention relates to a control device for a remote image receiver, and more particularly to an energy-saving control device electrically connected to a remote image receiver for controlling the on/off of power supply to the image receiver according to a differential signal input state of the image receiver.

### BACKGROUND OF THE INVENTION

A remote image transmission system is frequently used in a public place, such as an airport, a rapid transit railway station, a shopping mall, etc. The remote image transmission system includes a remote receiving device, such as an electronic signboard, a television, a display and so on. The remote receiving device, no matter what type, is connected via a signal transmission line to a front end transmission device, such as a DVD (digital versatile disk) image player, a computer or a notebook computer, so that an image signal output from the front end transmission device is transmitted via the signal transmission line to the remote receiving device for displaying at a remote location.

According to some remote image transmission techniques, image signal is transmitted via signal conversion. However, in the course of signal conversion, it is possible the image signal could not be perfectly transmitted under some situations. Particularly, in the remote image transmission, signal phase delay might occur and the remote receiving device could not recover the clock of the signal and accordingly, the exact signal.

Therefore, signal transmission between a front end transmission device and a remote receiving device by way of analog signal differentiation is developed. According to this way, a differential receiver module and a delay correction module are used at the remote receiving device to avoid the occurrence of phase delay in the differential signal and to avoid the problem of poor definition or smearing of the image shown on a screen. The differential signal is transmitted from a signal transmission interface to the differential receiver module and the delay correction module, and the delay correction module generates an image synchronizing signal to a display device. However, during the differentiate signal transmission, power must be continuously supplied to the remote receiving device for receiving the differentiate signal. Since the remote receiving device is not provided with any mechanism for automatically shutting down or cutting off the remote receiving device when there is not differentiate signal transmission, electric power will be continuously supplied to the remote receiving device even when the front end transmission device stops sending the differential signal or does not send any differential signal. Under this condition, electric power is unnecessarily wasted and the remote receiving device being continuously turned on for a long period of time tends to become overheated and have shortened service life accordingly.

Therefore, the conventional remote image receiving device has the following disadvantages: (1) consuming a high amount of electric energy; (2) tending to become overheated due to being continuously turned on for a long period of time; and (3) having shortened service life caused by overheat.

It is therefore tried by the inventor to develop an energy-saving control device for a remote image receiver; so as to solve the above-mentioned problems existed in the conventional remote image receiving device.

### SUMMARY OF THE INVENTION

A primary object of the present invention is to provide an energy-saving control device for a remote image receiver.

Another object of the present invention is to provide an energy-saving control device capable of automatically turning off a remote image receiver when the latter does not have image signal input thereto.

A further object of the present invention is to provide an energy-saving control device capable of automatically turning on a remote image receiver when the latter has image signal input thereto again.

To achieve the above and other objects, the energy-saving control device for remote image receiver according to the present invention is electrically connected to an image receiver that includes a differential demodulation module, a delay correction module, and a signal transmission interface for transmitting a differential signal converted from an image signal; and the differential signal is sequentially processed by the differential demodulation module and the delay correction before being output.

The energy-saving control device for remote image receiver according to the present invention includes a detection module, a control module, and a power control module. The detection module is electrically connected to the signal transmission interface for detecting a differential signal transmission state at the signal transmission interface, and generating a detection signal to the control module accordingly. The control module is electrically connected to the detection module and generates a control signal according to the detection signal. The power control module is electrically connected to the control module, the differential demodulation module and the delay correction module for controlling a power supply state of the image receiver according to the control signal.

In the present invention, the control device performs the following energy-saving procedures: the detection module detects the differential signal transmission state at the signal transmission interface, and generates the detection signal to the control module when the state at the signal transmission interface changes from having differential signal transmission into no differential signal transmission; and the control module generates the control signal to the power control module for the latter to automatically cut off the power supply to the image receiver.

On the other hand, the detection module generates the detection signal to the control module when the state at the signal transmission interface changes from no differential signal transmission into having differential signal transmission, and the control module generates the control signal to the power control module for the latter to automatically turn on the power supply to the image receiver.

Therefore, when the image receiver works, power can be continuously supplied to the image receiver; and when the differential signal transmission stops, the control device automatically cuts off the power supply to the image receiver to avoid unnecessary power consumption. On the other hand, when the detection module detects the differential signal transmission at the signal transmission interface starts again, the control device would immediately turn on the power supply to the image receiver for the same to work.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of an energy-saving control device for remote image receiver according to a first embodiment of the present invention;

FIG. 2 is an operation flowchart showing the energy-saving procedures of the energy-saving control device for remote image receiver according to the first embodiment of the present invention;

FIG. 3 is a block diagram of an energy-saving control device for remote image receiver according to a second embodiment of the present invention; and

FIG. 4 is a block diagram of an energy-saving control device for remote image receiver according to a third embodiment of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

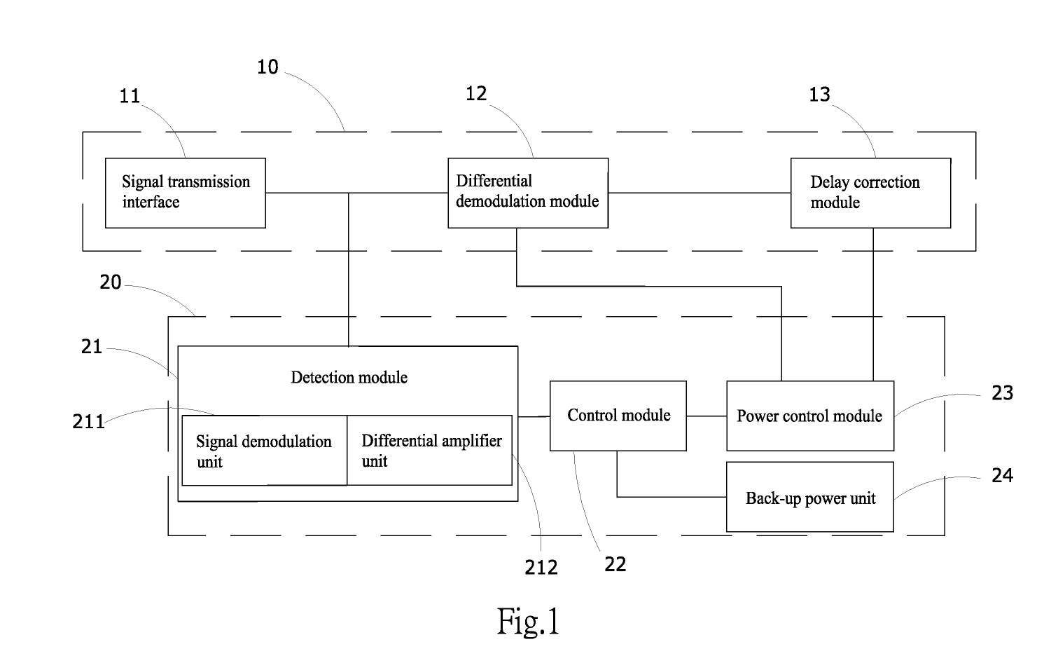

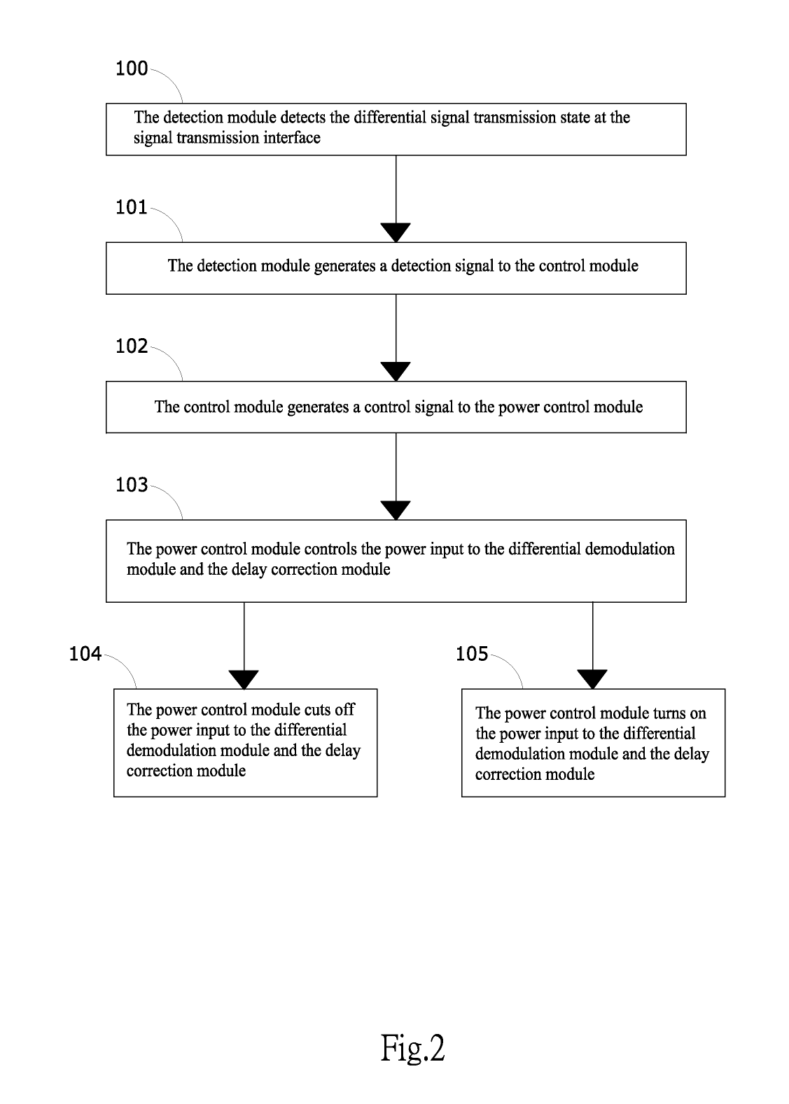

Please refer to FIGS. 1 and 2 that are block diagram and operation flowchart, respectively, for an energy-saving control device for remote image receiver according to a first embodiment of the present invention. As shown, the energy-saving control device for remote image receiver in the first embodiment is generally denoted by reference numeral 20, and is externally connected to an image receiver 10.

The image receiver 10 includes a signal transmission interface 11, a differential demodulation module 12, and a delay correction module 13. The signal transmission interface 11 receives and transmits a differential signal converted from an image signal. The differential signal includes a red, a green and a blue signal. The red signal, green signal and blue signal respectively include a horizontal synchronizing signal and a vertical synchronizing signal.

The signal transmission interface 11 is electrically connected to the differential demodulation module 12, and transmits the differential signal to the differential demodulation module 12. The differential demodulation module 12 receives the differential signal and demodulates the same to obtain RGB signals and synchronizing signals. The RGB signals include the above-mentioned red, green and blue signals; and the synchronizing signals include the above-mentioned horizontal synchronizing signals and vertical synchronizing signals. The delay correction module 13 is electrically connected to the differential demodulation module 12 and receives the RGB signals. The delay correction module 13 adjusts time delay for the red, green and blue signals, so as to output a synchronized image signal.

The control device 20 is electrically connected to the image receiver 10, and includes a detection module 21, a control module 22 and a power control module 23.

The detection module 21 includes a signal demodulation unit 211 and a differential amplifier unit 212. The detection module 21 is electrically connected to the signal transmission interface 11 for detecting a differential signal transmission state at the signal transmission interface 11 and generating a detection signal. After the detection module 21 receives the differential signal, the signal demodulation unit 211 demodulates the differential signal to obtain the horizontal synchronizing signals and the vertical synchronizing signals; and the differential amplifier unit 212 avoids noise in the differential signal and acquires small signals thereof, and then differentially amplifies the small signals to a detection signal of high-level or low-level long instruction. Therefore, when the signal demodulation unit 211 obtains the horizontal synchronizing signals and the vertical synchronizing signals, and detects a differential signal transmission at the signal transmission interface 11, the differential amplifier unit 212 generates a detection signal having high-level or low-level long instruction for turning power on or off. It is understood the above description of the detection manner of the detection module 21 is only illustrative and not intended to limit the actual detection manner of the detection module 21 in any way. Any technique or circuit structure that is able to detect any differential signal input shall fall within the protection scope of the present invention.

The control module 22 is electrically connected to the detection module 21 for receiving the detection signal generated by the detection module 21. Further, according to the detection signal, the control module 22 determines the on/off of power supply to the image receiver 10. In the illustrated first embodiment, the control module 22 is a microcontroller unit (MCU).

The power control module 23 is electrically connected to the control module 22, the differential demodulation module 12 and the delay correction module 13. When the control module 22 receives the detection signal and generates a control signal, the power control module 23 controls the power supply to the image receiver 10 according to the control signal, so as to turn on or cut off the power input to the differential demodulation module 12 and the delay correction module 13 while controls a power supply state of the image receiver 10. The control module 22 is further electrically connected to a back-up power unit 24. When the power control module 23 shuts down the power supply, the back-up power unit 24 keeps supplying power to the control module 22 and the detection 21 for them to continuously detect the state of differential signal input. It is noted the power control module 23 can be connected to the image receiver 10 in at least two different manners. In the first manner, the power control module 23 is connected to an internal power supply or a power input terminal of the image receiver 10. In the second manner, the power control module 23 is connected to a power supply device at a power output terminal thereof that is connected to the image receiver 10. The power supply device can be a central control circuit, a panel board or an uninterruptible power system. It is understood the above description of the implementing manners of the power control module 23 is only illustrative and not intended to limit the actual structure or circuit of the power control module 23 in any way, and any skills techniques that can be used to turn on/off power input to the differential demodulation module 12 and the delay correction module 13 as well as to control the power supply state of the image receiver 10 also fall within the protection scope of the present invention.

It is noted the control device 20 may be implemented in different forms, such as an integrated IC (integrated circuit) integrating the detection module 21, the control module 22, and the power control module 23 into one single IC circuit; or an integrated circuit with the detection module 21, the control module 22 and the power control module 23 respectively being an individually packaged IC and connected to one another via a printed circuit board (PCB); or an electronic circuit with the three modules 21, 22, 23 respectively being an electronic component and connected to one another via a PCB; or any combination of the above forms. Further, the control device 20 can be electrically connected to the image receiver 10 by mounting it in the image receiver 10, integrating it into an internal circuit of the image receiver 10, or externally electrically connecting it to the image receiver 10.

FIG. 2 shows the operation procedures 100˜105 of the energy-saving control device 20 according to the first embodiment of the present invention

In the operation procedure 100, the detection module 21 detects a differential signal transmission state at the signal transmission interface 11.

More specifically, in the operation procedure 100, the detection module 21 is electrically connected to the signal transmission interface 11 and starts detecting whether there is any differential signal transmission at the signal transmission interface 11.

In the operation procedure 101, the detection module 21 generates a detection signal to the control module 22.

More specifically, in the operation procedure 101, when a state at the signal transmission interface 11 is changed from having differential signal transmission into no differential signal transmission, or changed from no differential signal transmission into having differential signal transmission, the detection module 21 generates a detection signal to the control module 22.

In the operation procedure 102, the control module 22 generates a control signal to the power control module 23.

More specifically, in the operation procedure 102, the control module 22 generates a control signal according to a state represented by the detection signal, and the control signal is transmitted to the power control module 23 to determine the latter's movement. In the case the detection signal indicates the state at the signal transmission interface 11 is changed from having differential signal transmission into no differential signal transmission, the control signal controls the power control module 23 to cut off the power supply to the image receiver 10. On the other hand, when the detection signal indicates the state at the signal transmission interface 11 is changed from no differential signal transmission into having differential signal transmission, the control signal controls the power control module 23 to turn on the power supply to the image receiver 10.

In the operation procedure 103, the power control module 23 controls the power input to the differential demodulation module 12 and the delay correction module 13.

More specifically, in the operation procedure 103, the power control module 23 determines the power supply condition of the differential demodulation module 12 and the delay correction module 13 according to the control signal from the control module 22. In the case the state at the signal transmission interface 11 is changed from having differential signal transmission into no differential signal transmission, the operation procedure 104 is performed. On the other hand, when the state at the signal transmission interface 11 is changed from no differential signal transmission into having differential signal transmission, the operation procedure 105 is performed.

In the operation procedure 104, the power control module 23 cuts off the power input to the differential demodulation module 12 and the delay correction module 13.

And, in the operation procedure 105, the power control module 23 turns on the power input to the differential demodulation module 12 and the delay correction module 13.

With the energy-saving control device 20 of the present invention, when the image receiver 10 works, the detection module 21 of the control device 20 keeps detecting the differential signal transmission state at the signal transmission interface 11. When the signal transmission interface 11 does not transmit any differential signal, the control device 20 will cut off the power supply to the image receiver 10 so as to avoid unnecessary power consumption and protect the image receiver 10 against overheat and shortened service life due to being turned on over an excessively long period of time. On the other hand, when the signal transmission interface 11 transmits differential signal again, the control device 20 will resume the power supply to the image receiver 10 for the same to work immediately.

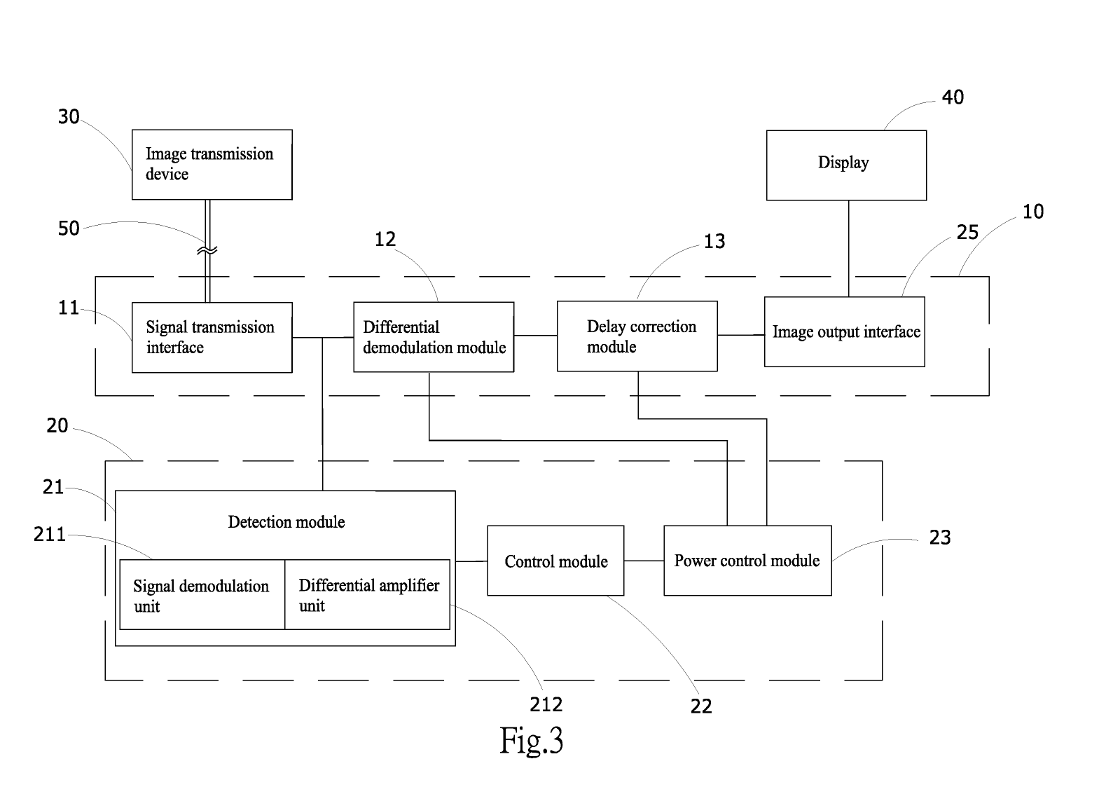

FIG. 3 is a block diagram of a second embodiment of the present invention. The second embodiment is generally structurally similar to the first embodiment, except that, in the second embodiment, the image receiver 10 is further electrically connected to an image transmission device 30 and a display 40, and further includes an image output interface 25. The image transmission device 30 is remotely connected to the signal transmission interface 11 via a cable 50 of several hundred meters in length, so that a differential signal converted from an image signal is sent from the image transmission device 30 to the signal transmission interface 11 via the cable 50. The cable 50 can be a category 5 cable (CAT 5), a category 5e cable (CAT 5e) or a category 6 cable (CAT 6) for connecting and transmitting the differential signal to the signal transmission interface 11. The differential demodulation module 12 demodulates the differential signal to obtain the RGB signals and the synchronizing signals. The delay correction module 13 receives the RGB signals and adjusts time delay for the red, green and blue signals thereof, so as to produce a synchronized image signal and outputs the same to the image output interface 25. The image output interface 25 receives the synchronized image signal and the synchronizing signals, and generates a VGA (Video Graphics Array) signal to the display 40 for displaying.

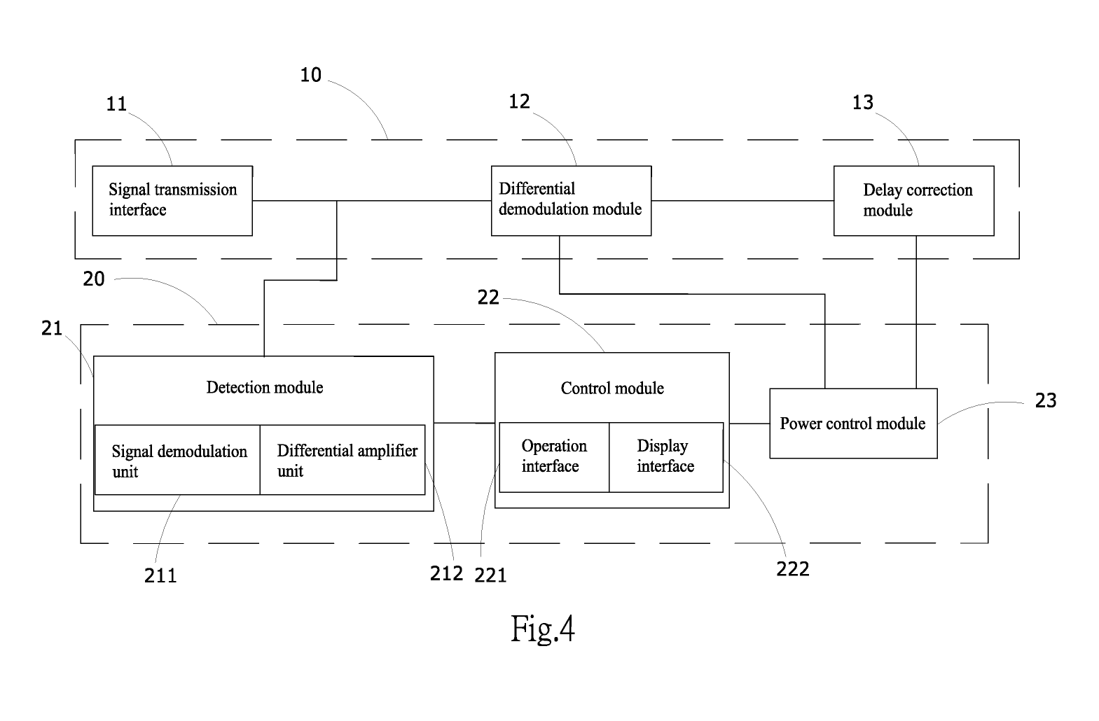

FIG. 4 is a block diagram of a third embodiment of the present invention. As shown, the third embodiment is generally structurally similar to the first embodiment, except that, in the third embodiment, the control module 22 of the control device 20 further includes an operation interface 221 and a display interface 222.

The operation interface 221 is electrically connected to the control module 22 for a user to set the movement for the control device 20. For example, the detection module 21 can detect and determine whether there is any differential signal transmission at the signal transmission interface 11 according to the duration or intervals of changes of the differential signal. That is, a sudden interruption lasted for a few seconds while the differential signal is being continuously input might occur due to signal delay or replacement of an image disc by a user. To avoid repeatedly turning on or off the image receiver 10 many times within a very short time period, the user may make settings via the operation interface 221, so that the control module 22 does not cut off the power supply to the image receiver 10 when the differential signal transmission is interrupted for only a short time not longer than a preset time. On the other hand, it is also possible a sudden differential signal transmission occurs at the signal transmission interface 11 and lasts a short time, such as a few seconds or a few fractions of a second, while the image receiver 10 is cut off. The user may make settings via the operation interface 221, so that the control module 22 does not turn on the power supply to the image receiver 10 when the differential signal transmission lasts only for a very short time period. It is noted the user can use the operation interface 221 to set the duration or intervals of changes of the above-mentioned short time periods for determining the on/off of power supply to the image receiver 10. Alternatively, the settings of the durations or intervals, during or at which the differential signal transmission changes, can be preset in the control module 22 of the energy-saving control device 20 shown in FIG. 1. With the third embodiment shown in FIG. 4, the user may operate at the operation interface 221 to change the preset settings. According to the present invention, the operation interface 221 may be a mechanical switch, such as a DIP (dual-in-line) switch, a toggle switch, a push-button switch, a rocker switch, a contact switch, a band switch, a micro switch or a proximity switch; or an electronic switch, such as a membrane switch or a touch switch; or a touch panel, such as a resistive touch panel, a capacitive touch panel, an optical touch panel, or a SAW (surface acoustic wave) touch panel.

The display interface 222 is electrically connected to the control module 22 for displaying the current state of the control device 20 or the image receiver 10. For instance, the display interface 222 may display the current on/off state of the image receiver 10. When the detection module 21 keeps detecting whether there is any differential signal input or any change in the differential signal transmission, the display interface 222 also displays the current state detected by the detection module 21, such as the number of times of noise input, the number of times of signal interruption, etc., so that the user can have an idea about the current working state of the image receiver 10 and the control device 20. Moreover, the display interface 222 may be a seven-segment display, an LED (light-emitting-diode) array display, or an LCD (liquid crystal display) panel.

It is understood that, in practical implementation of the present invention, the operation interface 221 and the display interface 222 are not necessarily provided at the same time. That is, the present invention can be designed according to actual need in application to include both or one of the operation interface 221 and the display interface 222.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An energy-saving control device for remote image receiver, being electrically connected to an image receiver that includes a differential demodulation module, a delay correction module, and a signal transmission interface for transmitting a differential signal; the differential signal being sequentially processed by the differential demodulation module and the delay correction before being output; the energy-saving control device comprising:
a detection module being electrically connected to the signal transmission interface for detecting a differential signal transmission state at the signal transmission interface, and generating a detection signal accordingly;
a control module for generating a control signal according to the detection signal; and
a power control module being electrically connected to the control module, the differential demodulation module and the delay correction module, and controlling an on/off state of power supply to the differential demodulation module and the delay correction module according to the control signal.

2. The energy-saving control device as claimed in claim 1, wherein the differential signal includes red, green and blue signals, which respectively include a horizontal synchronizing signal and a vertical synchronizing signal.

3. The energy-saving control device as claimed in claim 2, wherein the differential demodulation module demodulates the differential signal to obtain RGB signals and synchronizing signals.

4. The energy-saving control device as claimed in claim 3, wherein the RGB signals include the red, green and blue signals.

5. The energy-saving control device as claimed in claim 3, wherein the synchronizing signals include the horizontal synchronizing signals and vertical synchronizing signals.

6. The energy-saving control device as claimed in claim 3, wherein the delay correction module receives the RGB signals and outputs a synchronized image signal.

7. The energy-saving control device as claimed in claim 6, wherein the synchronized image signal is transmitted to an image output interface.

8. The energy-saving control device as claimed in claim 7, wherein the image output interface receives the synchronized image signal and the synchronizing signals, and generates a VGA signal.

9. The energy-saving control device as claimed in claim 1, wherein the detection module further includes a differential amplifier unit for acquiring and amplifying the differential signal, and generates the detection signal according to the differential signal.

10. The energy-saving control device as claimed in claim 2, wherein the detection module further includes a signal demodulation unit for demodulating the differential signal to obtain the horizontal synchronizing signals and the vertical synchronizing signals.

11. The energy-saving control device as claimed in claim 1, wherein the control module includes an operation interface.

12. The energy-saving control device as claimed in claim 11, wherein the operation interface is selected from the group consisting of a mechanical switch, an electronic switch, and a touch panel.

13. The energy-saving control device as claimed in claim 1, wherein the control module includes a display interface.

14. The energy-saving control device as claimed in claim 1, wherein the display interface is selected from the group consisting of a 7-segment display, an LED array display, and an LCD panel.

15. The energy-saving control device as claimed in claim 1, wherein the control module is a microcontroller unit (MCU).

16. The energy-saving control device as claimed in claim 1, further comprising a back-up power unit electrically connected to the control module.

17. The energy-saving control device as claimed in claim 2, wherein the detection module further includes a differential amplifier unit for acquiring and amplifying the differential signal, and generates the detection signal according to the differential signal.
